(19) United States
(12) Patent Application Publication
(10) Pub. No.: US 2003/0106016 A1
(43) Pub. Date: Jun. 5, 2003

(54) Process for storing electronic documents on an internet-accessible document storage system

(76) Inventors: John J. Kendrick JR., Dallas, TX (US); Robert N. Higbee, Plano, TX (US)

Correspondence Address: Timothy F Loomis, Law Offices of Timothy F Loomis, 2932 Hagen Drive, Plano, TX, 75025, US

(21) Appl. No.: 10/011,647

(22) Filed: Dec. 4, 2001

(51) Int. Cl. G06F 17/00; G06F 7/00

(52) U.S. Cl. 715/500.1; 707/104.1

(57) ABSTRACT

A process of preparing for the storage of electronic documents and storing these electronic documents upon a secure Internet-accessible document control system. The process provides for the storage to occur without having to print the documents onto paper and scan the documents into the document control system.

### FIELD OF THE INVENTION

This invention relates to providing a process of preparing for the storage of electronic documents and storing these electronic documents upon a secure Internet-accessible document control system.

### BACKGROUND OF THE INVENTION

A secure web-accessible document control system was the subject of U.S. patent application Ser. No. 09/783,161 to Brunt et al. filed on Feb. 14, 2001, which application is hereby incorporated by reference. This system permits users or customers to provide paper documents to a system operator and have those paper documents imaged, run through an optical character recognition process, and stored so that they are searchably accessible over a secure Internet link. The system is particularly useful in a litigation context, as it facilitates the organization, searchability and production of documents.

FIG. 1 (prior art) shows a secure web-accessible document control such as that covered by that application.

Referring to that figure, a database 75 for storing document images, document indexes and/or summaries (for simplicity purposes, the term index as used hereinafter shall mean index and/or summary), OCR records of documents and notes is provided. Preferably, the database is a RAID array. Alternatively, multiple separate databases or other electronic storage media could be used.

Document management service 70 is connected to database 75. Document management service 70 provides the interface between the database and the outside world. It provides the search capabilities and note making capabilities to users. Document management service 70 includes capabilities such as those provided by discovery management software commercially available from Precise Systems Corporation, including document collection, database creation, and indexing of documents.

Managers can be connected to the document management service 70, such as manager 65. Manager 65 can provide management functions, such as password assignment for authorized users, account management, other security functions and database administration.

Document management service 70 may also be connected to a hub 68 for providing access to the service for document workers 60-1 through 60-x. This permits document workers 60-1 through 60-x to scan, code and store the documents in database 75. When production of documents is to occur, document workers 60-1 through 60-x can produce the documents from the document management service 70 and the database 75.

Hub 68 and document management service 70 can be connected to a web server and firewall 80 for providing secure access to the Internet 90. As used herein, the Internet shall encompass not only the present day Internet, but any future network that provides the broad connectivity that the Internet currently does. A router 85 may be included for connection to Internet 90. By connecting hub 68 to the Internet 90, access is provided for document workers 60-1 through 60-x to the Internet 90 so that they may communicate with users should questions arise regarding the encoding, storing or production processes occur. Alternatively, if this arrangement causes security concerns, hub 68 could not be attached to webserver and firewall 80. Under this alternative arrangement, document workers 60-1 through 60-x would be forced to go through document control service 70 to access the Internet.

Users 101-1 through 101-x have access to the documents stored in database 75 through the Internet 90. Users 101-1 through 101-x would be permitted to access the images of documents created through the scanning process, such as image 71; through a search of indexes, such as index 72; or through a search of OCR files representing documents, such as OCR file 73. Again, document management service 70 would provide the search functions. Additionally, notes could be placed and viewed by a user, such as notes 74. Notes 74 should be associated with image 71 so that a user could selectively change between viewing image 71 and notes 74. Notes 74 should be associated with image 71 in such a way that they would appear to user to be the image 71 with certain text highlighted and/or with sticky pad notes attached. The highlighting could be, for instance, a contrasting color overlaid on the document, different colored text, boxed or circled text, bolded text, underlined text, italicized text, or the like.

User 101-z, a user operating a laptop from a location remote from his office and from the document storage area, is also connected through the Internet 90 to the document management service 70 and database 75. User 101-z interoperates with the central document storage area just as users 101-1 through 101-x, so that when a user that normally accesses the documents through a fixed location has to travel and needs to access the documents, the procedure he has to undertake is the same.

This system of FIG. 1, thus greatly improves document storage, handling, and production, particularly in a litigation context. However, one shortfall of the system of FIG. 1, is that there was no way to handle the direct processing of electronic information. Today many documents maintained by companies are electronic in form. Email, word processing documents, spreadsheets and slide presentations in electronic form are widespread at most companies. Many of these electronic documents do not exist in paper form.

When such documents had to be produced in litigation before using the system discussed in that application, the electronic documents had to be printed out in paper form from the program originating the document, transported to the location of the document storage system and then put through the same procedure as any other paper document including scanning the document back into an electronic form. This process is very time consuming and uses paper as a medium of transporting electronic information from one point to another.

Thus, a need exists for a process of storing electronic documents on a secure web-based document control system without requiring the electronic documents to be printed out into a hard copy and then scanned into the system.

### SUMMARY OF THE INVENTION

An embodiment of the present invention provides a process for entering electronic documents into a secure Internet-accessible document control system that permits authorized users to access the stored documents stored through the Internet from remote locations without the need to print the electronic documents onto paper and then scan the paper into the system in the process.

Another embodiment of the present invention provides a process for preparing to enter electronic documents into a secure Internet-accessible document control system that permits authorized users to access the stored documents stored through the Internet from remote locations without the need to print the electronic documents onto paper and then scan the paper into the system in the process.

As such, it is an object of the present invention to permit the storage of electronic documents on a secure Internet-accessible document control system without the need to transform the electronic documents into paper form and then scan the paper in the process.

It is a further object of the present invention to permit the preparation for the storage of electronic documents on a secure Internet-accessible document control system without the need to transform the electronic documents into paper form and then scan the paper in the process.

### BRIEF DESCRIPTION OF THE DRAWINGS

FIG. 1 (Prior Art) is a block diagram of a secure document system permitting remote users to access documents stored thereon according to the prior art.

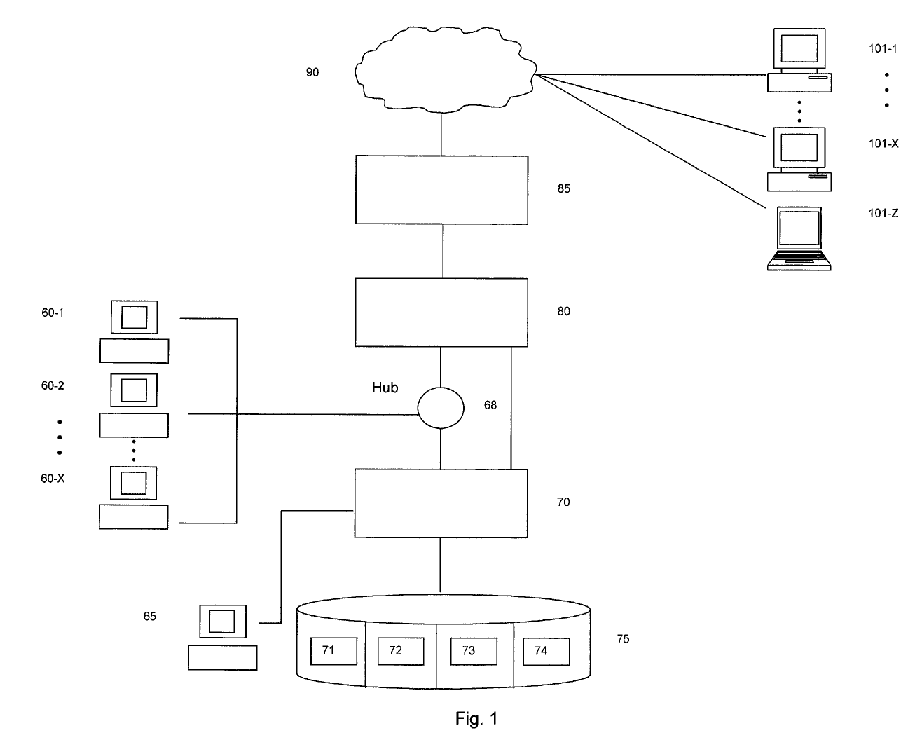

FIG. 2 is a flow chart showing the process of preparing for the storage of and storing electronic documents on the Internet-accessible secure document storage system according to an embodiment of the present invention.

### DESCRIPTION OF THE PREFERRED EMBODIMENTS

The present invention will be better understood by reference to the accompanying drawings.

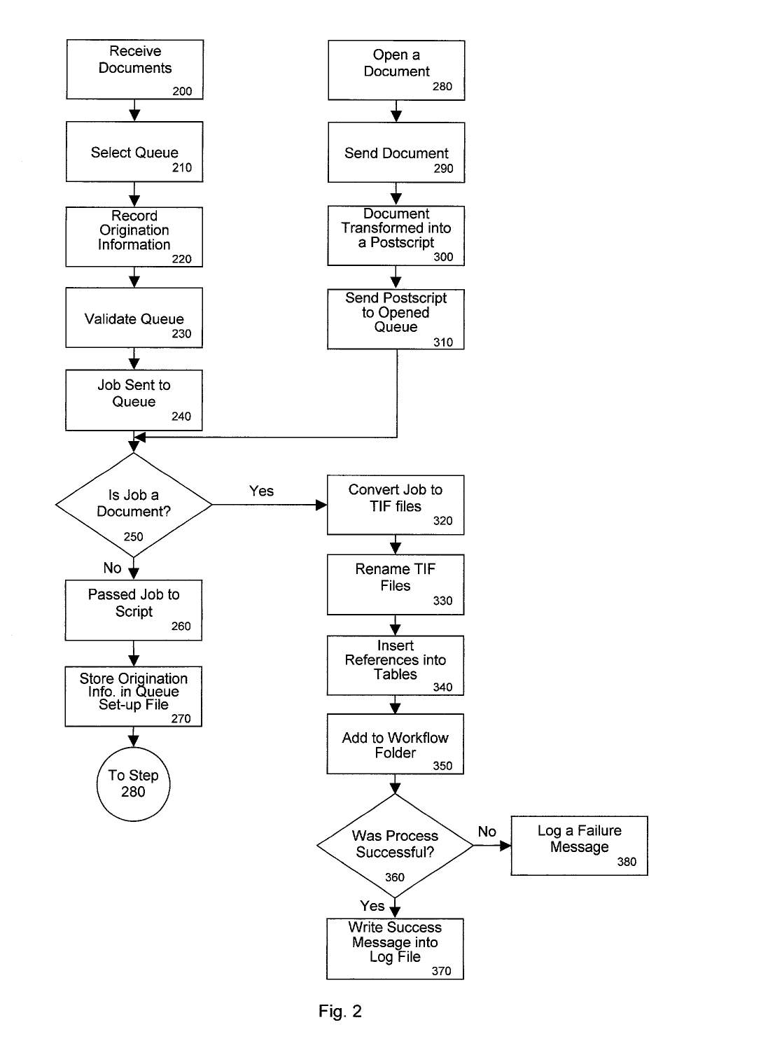

The process of preparing for the storage of electronic documents and storing such electronic documents into the secure Internet-accessible document storage system is shown in FIG. 2. In step 200, the electronic documents are received from a customer. These documents can be received as an attachment to email, on CD-ROM, on a floppy disc, or in any electronic form on any media. In step 210, a document worker, such as 60-1, selects a queue on a server, such as document management service 70. Preferably, the server is a Sun Solaris server. The document worker also selects a destination database, such as database 71, to inform the server where to store documents that arrive in the selected print queue.

In step 220, using an interface, the document worker may input origination information such as a box identifier, folder identifier and/or source identifier to be recorded for organizational and quality control reasons for the document. While this step is not critical, it may come in handy in the future if additional documents similar to a document stored in the system need to be found, for example, for production in litigation due to a court order. By recording this information, one may determine the source of the document and approximately where it was located in the producing parties' files. This will provide a starting point for searching for the additional documents.

In step 230, web server 80 validates the queue location and origination information and then submits a special print job to the appropriate queue to store this information in the queue in step 240. In step 250, when the job hits the top of the queue, it is determined whether the job is a special control file or a document. Because this first job is a special control file, in step 260, the file is passed to a script. In step 270, the script stores the information in a queue set-up file. The details on the preparation of the script is within the knowledge and skill of one skilled in the art. This queue set-up file records which database, box, folder and source to associate with subsequently spooled documents.

In step 280, the first document to be associated with the just input origination information is opened on the computer by the document worker. In step 290, the document is sent for transformation. This can be accomplished, for example, by selecting the print command in the program in which the document was originated. In step 300, a driver, preferably Adobe PS Generic PostScript Printer Driver, transforms the document into postscript, using a generic printer setup. In step 310, the resulting postscript file is transferred to the print queue on the server using the lpd protocol. This transfer can be accomplished by using ACITS software. The process then continues at step 250 where it is determined that the job is a document.

As it is a document, in step 320, the postscript job is converted into tif images—One page of the document per image. Preferably, ghostscript is used to perform the conversion. In step 330, the image files are renamed according to the PRV discovery name conventions. For instance, if the last document stored in the PLAY database is PLAY-0019876, the next document will be named PLAY-0019877.

In step 340, the page references are then inserted into a page table, and a document entry is inserted into a document table. This is done for organizational reasons and enables the server to retrieve the document upon user access once stored. The document is then added to a discovery workflow folder in step 350 for quality control check, optical character recognition process and storage in the appropriate database. In step 360, it is determined whether the process was successful. If it was, in step 370, a success message is written into a log file.

If the process is unsuccessful, in step 380, it removes the image from the print queue, removes the copy of the image from the server, removes the references to the image from the tables and logs a failure message. For unsuccessful attempts, the process can be configured to restart for the unsuccessful document, warn a document worker as to the unsuccessful attempt or continue on to the next document.

The process then continues from step 280 for the next document through the last document falling within the set origination parameters that have been entered. Then when new origination parameters need to be entered, the process reverts to step 200.

Because of the relative ease of this process compared with the former process necessitating the conversion of electronic documents to paper documents before storage, a user could even scan paper documents in at his location and forward the electronic resulting documents to the system for storage through this process rather than transporting paper documents to the location of the document storage system.

Once the documents have been through the above process, they can be quality controlled, privilege-reviewed and the like as discussed in U.S. patent application Ser. No. 09/783,161. The electronic documents can then be accessed and produced in the same manner discussed in that application.

Although the preferred embodiments of the present invention have been described and illustrated in detail, it will be evident to those skilled in the art that various modifications and changes may be made thereto without departing from the spirit and scope of the invention as set forth in the appended claims and equivalents thereof.

What is claimed is:

1. A process of storing an electronic document on an Internet-accessible document storage system comprising the steps of:
receiving an electronic document from a user;
selecting a database for storing said electronic document;
converting said electronic document into at least one image file; and
storing said at least one image file for access by said user.

2. A process as in claim 1, wherein said at least one image file comprises a tif file.

3. A process as in claim 1, wherein said converting step comprises:
converting said electronic document into a postscript file;
sending said postscript file to a queue on a server; and
converting said postscript file to said at least one image file.

4. A process as in claim 3, wherein said each of said at least one image file represents one page of said electronic document.

5. A process as in claim 3, further comprising the step of renaming said at least one image file.

6. A process as in claim 3, further comprising the step of inserting references related to said at least one image file into at least one table.

7. A process as in claim 6, wherein said inserting step comprises inserting a page reference into a page table and inserting a document reference into a document table.

8. A process as in claim 3, further comprising the step of determining if said process was successful.

9. A process as in claim 8, further comprising the step of recording a successful message into a log file if said process was successful.

10. A process as in claim 8, wherein if said process is unsuccessful, said process further comprises the steps of:
recording an unsuccessful message into a log file;
deleting said at least one image file;
restarting said process from said converting step.

11. A process for preparing for the storage of electronic documents on an Internet-accessible document storage system comprising the steps of:
selecting a queue for receiving said electronic documents;
entering origination information; and
storing said origination information in a queue set-up file associated with said queue.

12. A process as in claim 11, further comprising the step of validating said queue.

13. A process as in claim 11, further comprising the step of passing said origination information to a script prior to storing said origination information.
